(19) United States
(12) Patent Application Publication
(10) Pub. No.: US 2026/0163630 A1
(43) Pub. Date: Jun. 11, 2026

(54) SYSTEMS AND METHODS FOR ON-DEMAND BEAM ACTIVATION

(71) Applicant: Telefonaktiehbolaget LM Ericsson (PUBL), Stockholm (SE)

(72) Inventors: Sina Maleki, MALMÖ (SE); Ali Nader, Lund (SE); Nianshan Shi, Stockholm (SE); Philipp Bruhn, Herzogenrath (DE)

(21) Appl. No.: 19/125,652

(22) PCT Filed: Nov. 3, 2023
(86) PCT No.: PCT/EP2023/080679

§ 371 Date: Apr. 29, 2025

Related U.S. Application Data
(60) Provisional application No. 63/382,120, filed on Nov. 3, 2022.

(51) Int. Cl. H04B 7/06; H04W 76/28

(52) U.S. Cl. CPC H04B 7/06952; H04W 76/28

(57) ABSTRACT

A method (1200) by a first network node (105) for on-demand beam activation in a second network node (110) includes transmitting (1202), to the second network node, a beam activation request message, which includes a request for the second network node to activate one or more beams of the second network node. The first network node receives (1204), from the second network node, a beam activation response message in response to the beam activation request message. The beam activation response message includes an identifier for each of at least one beam that the second network node is, has, or will activate.

### TECHNICAL FIELD

The present disclosure relates, in general, to wireless communications and, more particularly, systems and methods for on-demand beam activation.

### BACKGROUND

Network energy consumption in New Radio (NR) increases with respect to Long Term Evolution (LTE) due to more complex hardware (HW) such as, for example, higher bandwidth (BW) and a greater number of antennas. This is more evident when the network operates in higher frequencies. Thus, it is important for the network to turn ON/OFF unused HW modules during inactive times. For example, in Frequency Range 2 (FR2 ), an NR gNodeB (gNB) can be configured with up to 64 beams and transmit up to 64 Synchronization Signal Blocks (SSBs). This implies 64 ports with many transceiver chains involved. Such SSBs are transmitted every 20 ms during 5 ms windows for the sake of providing coverage to potential User Equipments (UEs) even if there actually are no UEs present in the cell. Another example of energy costly always-on broadcast transmissions is System Information Block-1 (SIB1), which is typically transmitted (per beam) every 20/40 ms.

FIG. 1 illustrates the current 5^{th} Generation (5G) Radio Access Network (NG-RAN) architecture as described in 3GPP TS 38.401 v15.4.0.

As illustrated, the NG-RAN architecture consists of a set of gNBs connected to the 5^{th} Generation Core (5GC) through the NG interface. A gNB can support Frequency Division Duplex (FDD) mode, Time Division Duplex (TDD) mode, or dual mode operation. gNBs can be interconnected through the Xn interface. A gNB may consist of a gNB-Central Unit (gNB-CU or CU) and gNB-Distributed Units (gNB-DUs or DUs).

A gNB-CU and a gNB-DU are connected via F1 interface. One gNB-DU is typically connected to only one gNB-CU. For resiliency though, a gNB-DU may be connected to multiple gNB-CU by appropriate implementation. NG, Xn and F1 are logical interfaces.

The NG-RAN is further layered into a Radio Network Layer (RNL) and a Transport Network Layer (TNL). The NG-RAN architecture, which includes the NG-RAN logical nodes and the interfaces between them, is defined as part of the RNL. For each NG-RAN interface (i.e., NG, Xn, F1), the related TNL protocol and the functionality are specified. The TNL provides services for user plane transport and signaling transport.

A gNB may also be connected to an LTE eNodeB (eNB) via the X2 interface. An architectural option is that an LTE eNB is connected to the Evolved Packet Core (EPC) and is also connected over the X2 interface with a gNB. The gNB is not directly connected to any Core Network (CN) but only connected via X2 to an eNodeB (eNB) for the sole purpose of performing dual connectivity (DC).

The NG architecture in FIG. 1 can be expanded by spitting the gNB-CU into two entities: a gNB-CU-User Plane (gNB-CU-UP) and a gNB-CU-Control Plane (gNB-CU-CP). The gNB-CU-UP serves the user plane and hosts the Packet Data Convergence Protocol (PDCP). The gNB-CU-CP serves the control plane and hosts the PDCP and Radio Resource Control (RRC) protocol. A gNB-DU hosts the Radio Link Control (RLC)/Medium Access Control (MAC)/Physical (PHY) protocols.

### NG-RAN Node Configuration Update Procedure

Clause 8.4.2 of 3GPP TS 38.423 v17.2.0 describes the NG-RAN Node Configuration Update procedure, which allows an NG-RAN node to transmit, to a neighboring NG-RAN node, an update of configuration information that is essential for the two NG-RAN nodes to interoperate correctly over the Xn-C interface.

The NG-RAN node Configuration Update procedure uses non-UE-associated signaling. FIG. 2 illustrates a successful NG-RAN Configuration Update procedure. Specifically, the first NG-RAN node initiates the procedure by sending a NG-RAN NODE CONFIGURATION UPDATE message to a second NG-RAN node. The NG-RAN NODE CONFIGURATION UPDATE message may comprise a list of served NR cells to update, or a list of served E-UTRA cells to update, or both, which may comprise a Served Cells NR To Modify IE and Served Cells E-UTRA To Modify IE, respectively.

If the Deactivation Indication IE is comprised in the Served Cells NR To Modify IE, it indicates that the corresponding cell was switched off for network energy saving. Analogously, if the Deactivation Indication IE is comprised in the Served Cells E-UTRA To Modify IE, it indicates that the corresponding cell was switched off for network energy saving.

Upon receipt of this message, the second NG-RAN node should update the configuration data associated to the first NG-RAN node that it has stored locally. If the NG-RAN configuration update is successful, the second network node sends a NG-RAN NODE CONFIGURATION UPDATE ACKNOWLEDGE.

By contrast, FIG. 3 illustrates an unsuccessful NG-RAN Configuration Update procedure. More specifically, if the second NG-RAN node cannot accept the update it should respond with a NG-RAN NODE CONFIGURATION UPDATE FAILURE message and with an appropriate cause value.

Further details are disclosed in 3GPP TS 38.423 v17.2.0.

### Cell Activation Procedure

Clause 8.4.3 of TS 38.423 v17.2.0 describes the Cell Activation procedure, which enables an NG-RAN node to request a neighbouring NG-RAN node to switch on one or more cells that have been reported as turned off for network energy saving at an earlier point in time. The Cell Activation procedure uses non-UE-associated signaling. FIG. 4 illustrates a successful Cell Activation procedure. Specifically, as shown in FIG. 4, a first NG-RAN node initiates the procedure by sending a CELL ACTIVATION REQUEST message to a second NG-RAN node.

Upon receipt of this message, the second NG-RAN node should switch on the cell(s) indicated in the CELL ACTIVATION REQUEST message and afterwards indicate in a CELL ACTIVATION RESPONSE message to the first NG-RAN node for which cell(s) the request was fulfilled.

If the second NG-RAN node turns on one or more cells upon receipt of a CELL ACTIVATION REQUEST message from the first NG-RAN node, and if the second NG-RAN node afterwards responds to said request via a CELL ACTIVATION RESPONSE message, the second NG-RAN node shall not send a NG-RAN CONFIGURATION UPDATE message to inform the first NG-RAN node about cell activation state change(s).

By contrast, FIG. 5 illustrates an unsuccessful Cell Activation procedure. Specifically, if the second NG-RAN node cannot turn on any of the cells indicated in the CELL ACTIVATION REQUEST message sent by the first NG-RAN node, it shall respond with a CELL ACTIVATION FAILURE message with an appropriate cause value.

For further details, are disclosed in 3GPP TS 38.423 v17.2.0.

### SUMMARY

Certain aspects of the disclosure and their embodiments may provide solutions to these or other challenges.

According to certain embodiments, a method by a first network node for on-demand beam activation in a second network node includes transmitting, to the second network node, a beam activation request message, which includes a request for the second network node to activate one or more beams of the second network node. The first network node receives, from the second network node, a beam activation response message in response to the beam activation request message. The beam activation response message includes an identifier for each of at least one beam that the second network node is, has, or will activate.

According to certain embodiments, a first network node for on-demand beam activation in a second network node includes processing circuitry configured to transmit, to the second network node, a beam activation request message, which includes a request for the second network node to activate one or more beams of the second network node. The processing circuitry is configured to receive, from the second network node, a beam activation response message in response to the beam activation request message. The beam activation response message includes an identifier for each of at least one beam that the second network node is, has, or will activate.

According to certain embodiments, a method by a second network node for on-demand beam activation by a first network node includes receiving, from the first network node, a beam activation request message, which includes a request for the second network node to activate one or more beams of the second network node. The second network node transmits, to the first network node, a beam activation response message in response to the beam activation request message. The beam activation response message includes an identifier for each of at least one beam that the second network node is, has, or will activate.

According to certain embodiments, a second network node for on-demand beam activation by a first network node includes processing circuitry configured to receive, from the first network node, a beam activation request message, which includes a request for the second network node to activate one or more beams of the second network node. The second processing circuitry is configured to transmit, to the first network node, a beam activation response message in response to the beam activation request message. The beam activation response message includes an identifier for each of at least one beam that the second network node is, has, or will activate.

Certain embodiments may provide one or more of the following technical advantage(s). For example, certain embodiments may provide a technical advantage of enabling one network node to ask another network node to not only activate, but to activate in specific beams. This may enable network energy savings. Optionally, certain embodiments, provide a technical advantage of enabling the first network node to specify what functions/signalling to activate (or not to activate) in those specific beams, which may provide further network energy savings. Optionally, certain embodiments, enable one network node to ask another network node to activate in specific beams even when the another network node is already active, if those specific beams are not active.

As another example, certain embodiments may provide a technical advantage of enabling the second node to determine which of the beams and associated functions within the requested beams and functions the second node should actually activate. For example, if the requested beams and functions are not necessary and the second network node may save energy, the second network node may not activate all of the requested beams and functions and/or may activate alternative beams.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the 5^{th} Generation (5G) Radio Access Network (NG-RAN) architecture as described in 3GPP TS 38.401 v15.4.0;

FIG. 2 illustrates a successful NG-RAN Configuration Update procedure;

FIG. 3 illustrates an unsuccessful NG-RAN Configuration Update procedure;

FIG. 4 illustrates a successful Cell Activation procedure;

FIG. 5 illustrates an unsuccessful Cell Activation procedure;

FIG. 6 illustrates a signalling diagram for implementing an example method for a first network node to request a second network node to activate one or more specific beams, according to certain embodiments;

FIG. 7 illustrates an example scenario for applying the method where a first network node is a gNB-DU of an NG-RAN node and a second network node is a gNB-CU (or a gNB-CU-CP) of the same NG-RAN node, according to certain embodiments;

FIG. 8 illustrates an example scenario for applying the method between different DUs of a NG-RAN node with a split architecture, according to certain embodiments;

FIG. 9 illustrates an example scenario for applying the method between different DUs of different NG-RAN nodes within split architecture, according to certain embodiments;

FIG. 10 illustrates an example scenario for applying the method between a DU of an NG-RAN node with split architecture and an eNB, according to certain embodiments;

FIG. 11 illustrates an example communication system, according to certain embodiments;

FIG. 12 illustrates an example UE, according to certain embodiments;

FIG. 13 illustrates an example network node, according to certain embodiments;

FIG. 14 illustrates a block diagram of a host, according to certain embodiments;

FIG. 15 illustrates a virtualization environment in which functions implemented by some embodiments may be virtualized, according to certain embodiments;

FIG. 16 illustrates a host communicating via a network node with a UE over a partially wireless connection, according to certain embodiments;

FIG. 17 illustrates an example method by a first network node for on-demand beam activation in a second network node, according to certain embodiments; and

FIG. 18 illustrates an example method by a second network node for on-demand beam activation by a first network node.

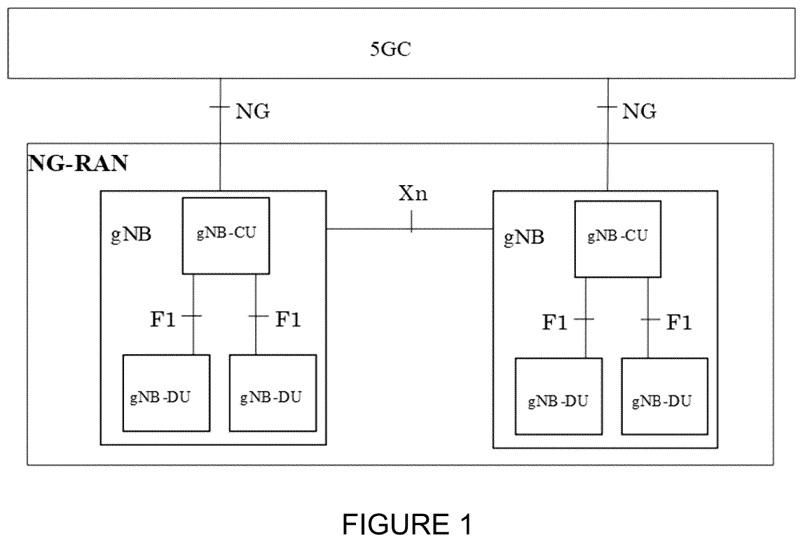

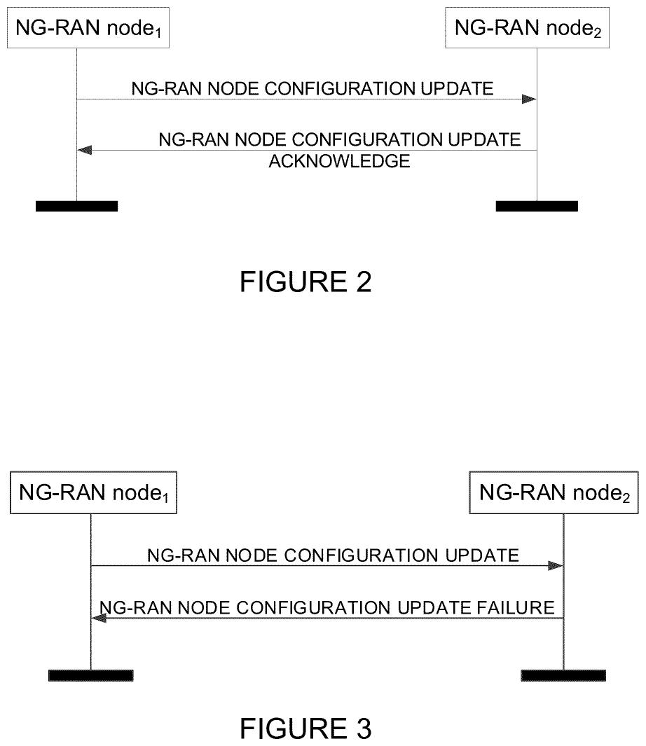

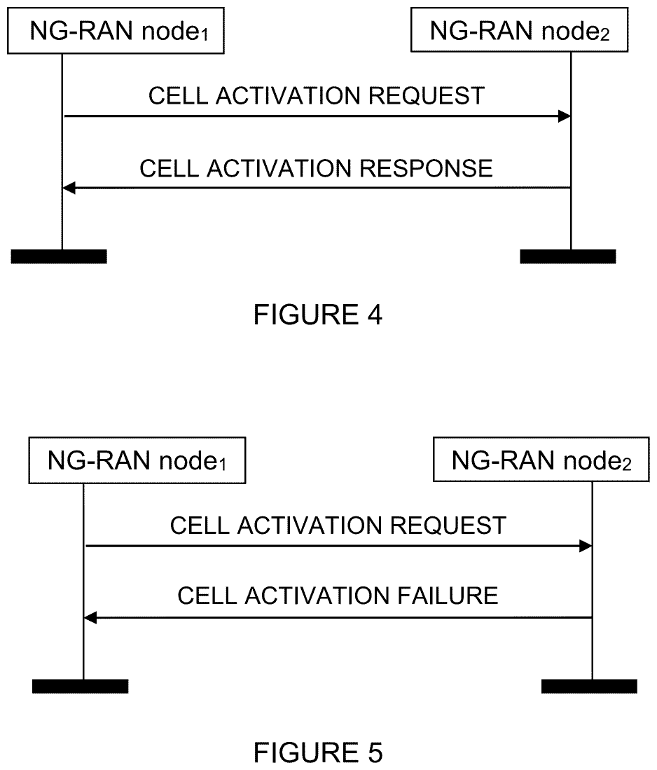

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (network node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g., in a gNB), Distributed Unit (e.g., in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to certain embodiments disclosed herein, methods and systems are provided for enabling a first network node to request a second network node to activate one or more specific beams, rather than all beams defining a cell which is the method according to existing technology. For example, according to certain embodiments, a method by a first network node for on-demand beam activation in a second network node includes transmitting, to the second network node, a beam activation request message, which includes a request for the second network node to activate one or more beams of the second network node. The first network node receives, from the second network node, a beam activation response message in response to the beam activation request message. The beam activation response message includes an identifier for each of at least one beam that the second network node is, has, or will activate.

As another example, according to certain embodiments, a method by a second network node for on-demand beam activation by a first network node includes receiving, from the first network node, a beam activation request message, which includes a request for the second network node to activate one or more beams of the second network node. The second network node transmits, to the first network node, a beam activation response message in response to the beam activation request message. The beam activation response message includes an identifier for each of at least one beam that the second network node is, has, or will activate.

Thus, according to certain embodiments, the second network node may take the control of the beam activation overview of the cell. Because a network node such may receive many incoming requests from different (first) network nodes, if the second network node does not take control of the beam activation, the second network node may end up activating all the beams in the cell even where such activation may increase network energy usage without providing the best service. For example, assume a (first) Node 1 requests the second network node to active Beam A and B and a (first) Node 2 requests the second network node to active Beam C and D. If a (first) Node 3 then requests the second network node to active Beam E, then certain embodiments described herein enable the second node to determine to use Beam B instead for (first) Node 3 instead of the requested Beam 3. The second network node may provide feedback to the first node (Node 3) indicating that Beam B is equivalent to Beam E and that Beam B is activated and ready for use. This may ensure that the second Node is able to better plan for network energy saving and provide the best service.

Furthermore, upon beam activation, the applicant has appreciated that it is not always necessary for the second network node to transmit other associated signaling such as one or more of SIBs and paging. For example, in a particular embodiment, it may be that the first cell is overlapping the second cell/node and is currently transmitting the SIBs and/or paging of the second cell/node on behalf of the second cell/node.

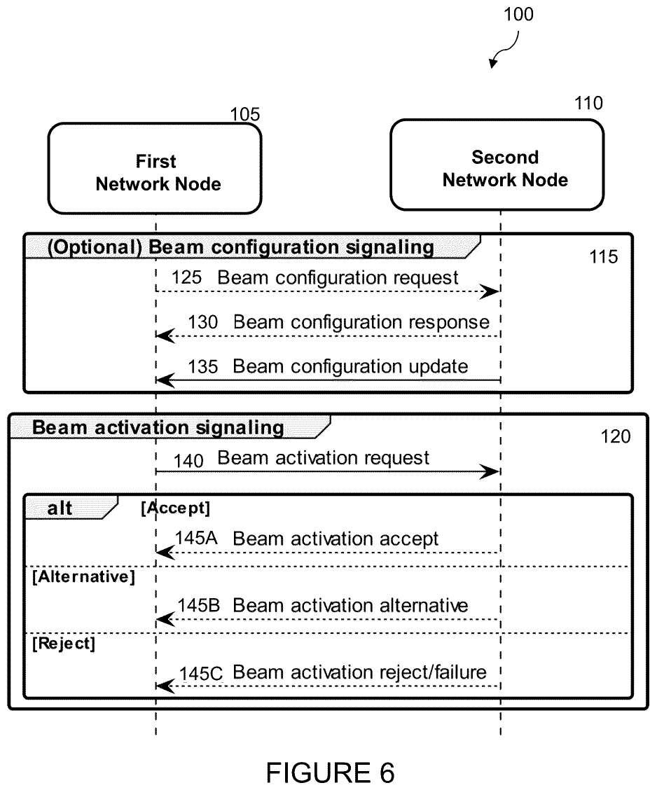

FIG. 6 illustrates a signaling diagram 100 for implementing an example method for a first network node 105 (e.g., RAN node) to request a second network node 110 (e.g., RAN node) to activate one or more specific beams, according to certain embodiments. In the depicted example embodiment, the signaling diagram 100 includes two types of signaling (procedures) between two network nodes of a communication network. The first type of signaling procedure is an optional beam configuration signaling (procedure) 115. The second type of signaling procedure is a beam activation signaling (procedure) 120. It is recognized, however, that the example method may also be implemented as a single signaling (procedure) between the two network nodes.

The optional beam configuration signaling (procedure) 115 includes three messages, in the depicted example. First, in an optional first message 125, the first network node 105 may send a beam configuration request, which requests the second network node 110 to transmit information concerning one or more beams of the second network node 110 to the first network node 105. In an optional second message 10, the second network node 110 transmits, to the first network node 105, a beam configuration response message, which responds to the first network node 105 with a positive or negative acknowledgement relating to the request received from the first network node 105. Additionally or alternatively, in a third message 135, the second network node 110 transmits, to the first network node 105, a beam configuration update message, which includes information concerning one or more beams of the second network node 110 (e.g., as per request in the first message 125 and/or as acknowledged/indicated in the second message 130, if applicable).

As depicted in FIG. 6, the beam activation signaling (procedure) 120 includes two messages: a beam activation request message 140 and a beam activation response message, wherein the beam activation response message comprises different variants 145A, 145B, 145C, which include alternative message contents.

Specifically, according to the beam activation signaling (procedure) 120, in a fourth message 140, the first network node 105 sends a beam activation request, which requests the second node to activate or reactivate and/or change the configuration of one or more beams of the second network node 110. In response, the second network node 110 may respond to the first network node 105 with one of the following:
In an optional fifth message 145A, the second network node 110 responds with a positive acknowledgement relating to the request received from the first network node 105. For example, fifth message 145A may indicate that second network node 110 will perform the requested activation and/or apply the requested reconfiguration of the one or more beams.
In an optional sixth message 145B, the second network node 110 responds with one or more alternatives for activation and/or reconfiguration of one or more beams of the second network node 110 that the second network node 110 has, could, and/or will perform instead.
In an optional seventh message 145C, the second network node 110 responds with a negative acknowledgement relating to the request received from the first network node 105. For example, seventh message 145C may indicate that second network node 110 will not and/or cannot perform the requested activation and/or apply the requested reconfiguration of the one or more beams. Optionally, in a particular embodiment, seventh message 145C may include an appropriate cause value indicating a cause for why the second network node 110 will not and/or cannot perform the requested activation.

Further details of the depicted and described example method are described below.

### Example Method Between Two Nodes

According to certain embodiments, a method is provided where a first network node 105 requests a second network node 110 to activate a first or a second beam or more over network interfaces such as, for example, F1, Xn, as described above with respect to step 140 of FIG. 6.

In a further particular embodiment, the first network node 105 additionally, as part of the activated beam configuration, requests from the second network node 110 to activate or to not activate one or more functions such as system information broadcast and/or multicast and broadcast service (MBS) and/or paging transmission within the activated beam where potentially different functions could be activated for different beams (e.g., in step 140 of FIG. 6).

In a further particular embodiment, the first network node 105 acquires the beam configuration of the second network node 110 while the second network node 110 is in active mode and stores it (e.g., in step 135 of FIG. 6). In one realization, the first network node 105 explicitly requests the second network node 110 to transmit the beam configuration to the first network node 105 (e.g., in step 125 of FIG. 6), while in another example, the second network node 110 transmits its beam configuration to the first network node 105 such as, for example, when the second network node 110 goes to inactive or deactivated mode. In one example, the first network node 105 can request the second network node's beam configuration anytime it wants, and potentially including/subject to a prohibition timer, while in another example, the first network node 105 can only request the second network node's beam configuration if the second network node 110 goes to deactivated mode. A prohibition timer is a timer upon its expiry the first network node 105 is allowed to request the second network node's beam configuration again. Alternatively, the second network node 110 can transmit its beam configuration to the first network node 105 in pre-configured occasions such as, for example, on a periodic basis to the first network node 105 (e.g., in step 135 of FIG. 6). In another alternative, the second network node 110 can transmit its beam configuration to the first network node 105 upon, for example, modification/reconfiguration by the second node (e.g., in [120]). In another embodiment, the first node can request the second node 110 to transmit the (new) beam configuration to the first network node 105 when the second network node's beam configuration is modified/reconfigured by the second network node 110 (e.g., in step 125 of FIG. 6).

In a further particular embodiment, one or more mechanisms above are also possible when the second network node 110 is in deactivated mode. For example, when the second network node 110 is in deactivated mode, the first network node 105 is allowed to ask for its beam configuration (e.g., in step 125 of FIG. 6), and potentially with/subject to different prohibition timers than when the second network node 110 is in active state. In a particular embodiment, for example, the first network node 105 only asks the second network node 110 for its beam configuration if the first network node 106 intends to ask the second network node 110 to become active; otherwise, the first network node 105 cannot. Therefore, in this case, a first network node 105 indicates to the second network node 110 that it should become active and, therefore, asks for its beam configuration. In response to receiving the beam configuration from the second network node 110, the first network node 105 indicates to the second network node 110 to become active and particularly turn on a first or a second or more beams and associated functions.

In a further particular embodiment, the first network node 105 is allowed to indicate to the second network node 110 to activate a first or a second or more beams even when the second network node 110 is active, but those specific beams are not active. This permission can be based on pre-configuration such as, for example, according to standardization documentations or OAM configuration, or it can be based on explicit permission from the second network node 110.

In a further particular embodiment, the first network node 105 is allowed to indicate to the second network node 110, when the beams are activated, if the DTRX should be on or off and/or whether certain transmissions such as MBS, SIB, paging should be on or off (e.g., in step 140 of FIG. 6). This is to ensure that when certain a service (e.g., high bitrate, low latency) is to be served the second network node 1110 is prepared.

In a further particular embodiment, the second network node 110 may take into consideration of the incoming request and activate/use other beams which may better suit the purpose of network energy saving and the services requirement, instead of the ones requested. The second network node 110 shall feedback to the first network node 105 in a beam activation response message (insteps 145A-C of FIG. 6), upon the request to activate the beams and the associated functions in the cell (e.g., in step 140 in FIG. 6), if the request is fulfilled, and if not, the replacement beams that are activated in the cell to be used (in steps 145A-C of FIG. 6).

In a further particular embodiment, the second network node 110 may feedback to the first network node 105 all the activated beams (e.g., in step 145A of FIG. 6), in addition to the beams that are/were requested to be activated.

In a further particular embodiment, when first network node 105 activates the cells in another node (e.g., second network node 110), it indicates that the cell DTRX should be on or off, based on the needs to active the cell.

In a further particular embodiment, the first network node 105 may provide a timer for the DTRX should be on. When the time expires, the second network node 110 takes control of the cell DTRX.

In a further particular embodiment, the first network node 105 may provide the cell DTRX configuration for the second network node 110 when the cell is activated.

In a further particular embodiment, the second network node 110 may provide feedback if the cell DTRX configuration is fulfilled or not.

In a further particular embodiment, the second network node 110 may provide feedback on its DTRX configuration.

### Node-Level Architecture Options

An example method is described above for a first network node 105 and a second network node 110. Hereafter, some non-limiting examples of the method are provided for specific technologies (e.g., 3GPP LTE/E-UTRAN and/or 5G/NG-RAN systems).

In a particular embodiment, for example, the first network node 105 is a first RAN node (e.g., a gNB or an eNB) and a second network node 110 is a second RAN node (e.g., another gNB or another eNB). The communication between the first network node 105 and the second network node 110 can occur directly or indirectly (e.g., via XnAP, X2AP), or via a third network node (e.g., NGAP, S1AP).

In a particular embodiment, the first network node 105 and the second network node 110 are enhanced NodeBs of a 3GPP E-UTRAN system. In this case, the beam configuration signaling messages shown at steps 125, 130, 135 of FIG. 6, as well as the beam activation signaling messages shown at steps 140 and 145A-C may be exchanged using a X2 interface of the E-UTRAN system (e.g., LTE and/or LTE-A).

In another particular embodiment, the first network node 105 and the second network node 110 are NG-RAN nodes (e.g., gNB) of a 3GPP NG-RAN system (also knowns as NR system). In this case the beam configuration signaling messages shown at steps 125, 130, 135 of FIG. 6 and the beam activation signaling messages shown at steps 140 and 145A-C can be exchanged using an Xn interface of the NG-RAN system (e.g., NR and/or NR-A).

In another particular embodiment, the first network node 105 is an NG-RAN node of an NG-RAN system, while the second network node 110 is enhanced NodeB (e.g., eNB) of an E-UTRAN system. In this case, the beam configuration signaling messages shown at steps 125, 130, 135 of FIG. 6 and the beam activation signaling messages shown at steps 140 and 145A-C can be exchanged using a X2 interface between the E-UTRAN system and NG-RAN system. Without loss of generality, the first network node 110 could be a RAN node, or a logical node of a RAN node.

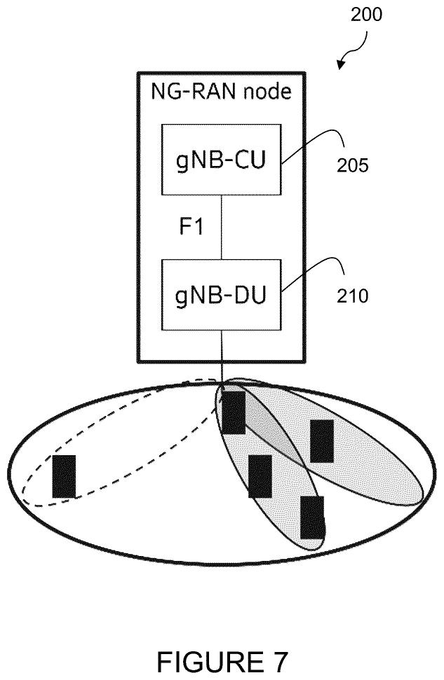

In a particular embodiment with a distributed architecture, for example, a first network node 105 is a first logical entity of a RAN node, and the second network node 110 is a second logical entity of a RAN node. In one scenario, the first network node 105 and the second network node 110 can be two different logical entities of the same RAN node. For example, FIG. 7 illustrates an example scenario 200 for applying the method 100 where first network node 105 is a gNB-CU 205 and second network node 110 is a gNB-DU 210 of a same NG-RAN node. Alternatively, the method 100 may be applied where the first network node 105 is a gNB-DU 210 and the second network is a gNB-CU 205, as illustrated in FIG. 7. In either case, the beam configuration signaling messages shown at steps 125, 130, 135 of FIGS. 6100, 110, 120 and the beam activation signaling messages shown at steps 140 and 145A-C 130, 140, 150, 160 can be exchanged using an F1 interface of the NG-RAN system, such as that as illustrated in FIG. 7.

In another particular embodiment, the first network node 105 and the second network node 110 are two logical entities of two different RAN nodes. Examples of logical entities of a RAN node are, e.g., the CU of an NG-RAN node (e.g., a gNB-CU or the corresponding control plane entity gNB-CU-CP) and the DU of an NG-RAN node (e.g., a gNB-DU). If present, a third network node is a third logical entity of a RAN node (e.g., a second gNB-DU).

In a particular embodiment, the first network node 105 is a first CU of a NG-RAN node (e.g., a gNB-CU), while the second network node 110 is a second DU of a NG-RAN node (e.g., a gNB-CU). In this case, the beam configuration signaling messages shown at steps 125, 130, 135 of FIG. 6 and the beam activation signaling messages shown at steps 140 and 145A-C can be exchanged using an F1 interface of the NG-RAN system.

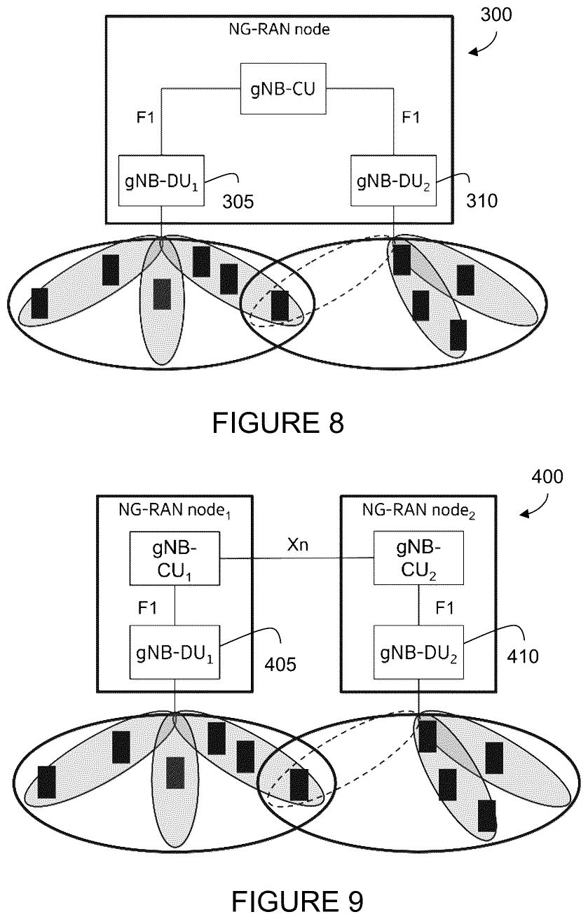

FIG. 8 illustrates any example scenario 300 for applying the method to exchange at least one beam configuration and/or request at least one beam activation between different DUs 305 and 310 of a NG-RAN node with split architecture such as, for example, between different DUs controlling different (e.g., neighboring) radio cells. In this example, an NG-RAN node consists of three or more logical nodes comprising multiple DUs (i.e., multiple gNB-DUs) controlled by a single CU (i.e., a gNB-CU). In one embodiment, the method can be applied to pairs of network nodes in a system with network nodes to exchange at least one beam configuration and/or request at least one beam activation. In the example of FIG. 8, two gNB-DUs exchange the at least one beam configuration and/or request the at least one beam activation via a gNB-CU (or the corresponding gNB-CU-CP). The method is thereby applied:
Between the gNB-DU₁ and the gNB-CU, with communication over an F1 interface.
Between the gNB-CU and the gNB-DU₂, with communication over an F1 interface.

In a particular embodiment, the first network node 105 is a first CU of a first NG-RAN node (e.g., a gNB-CU₁), while the second network node 110 is a second CU of a second NG-RAN node (e.g., a gNB-CU₂). In this case, the beam configuration signaling messages shown at steps 125, 130, 135 of FIG. 6 and the beam activation signaling messages shown at steps 140 and 145A-C can be exchanged using an Xn interface of the NG-RAN system.

FIG. 9 further illustrates an example scenario 400 for applying the method to exchange at least one beam configuration and/or request at least one beam activation between different DUs 405 and 410 of different NG-RAN nodes with split architecture, e.g., between different DUs controlling different (e.g., neighboring) radio cells. In this example, two gNB-DUs of two different NG-RAN nodes communicate via the respective centralized units, i.e. gNB-CU₁ and gNB-CU₂ (or the gNB-CU₁-CP and the gNB-CU₂-CP) respectively, to exchange at least one beam configuration and/or request at least one beam activation. The method is thus applied:
Between the gNB-DU₁ and the gNB-CU₁, with communication over an F1 interface.
Between the gNB-CU₁ and the gNB-CU₂, with communication over an Xn interface.
Between the gNB-CU₂ and the gNB-DU₂, with communication over an F1 interface.

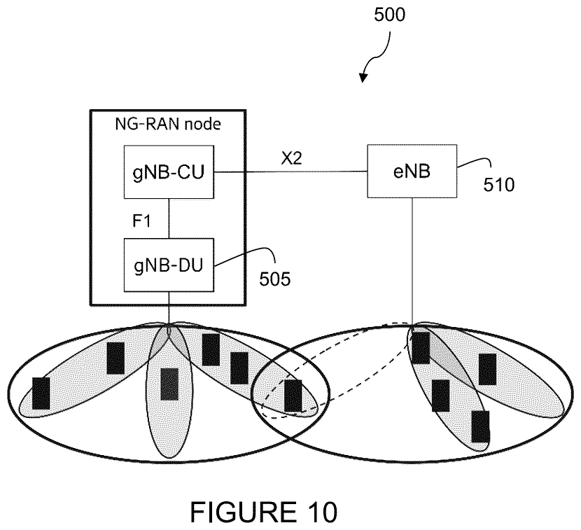

FIG. 10 illustrates an example scenario 500 for applying the method to exchange at least one beam configuration and/or request at least one beam activation between a DU 505 of an NG-RAN node with split architecture and an enhanced NodeB 510 (e.g., eNB) such as, for example, where the DU 505 and the eNB 510 control different (e.g., neighboring) radio cells. In this example, a gNB-DU 505 of an NG-RAN node communicates via its CUs (i.e., gNB-CU (or the gNB-CU-CP)), with an eNB 510 to exchange at least one beam configuration and/or request at least one beam activation. The method is therefore applied:
Between the gNB-DU and the gNB-CU, with communication over an F1 interface.
Between the gNB-CU and the eNB, with communication over an X2 interface.

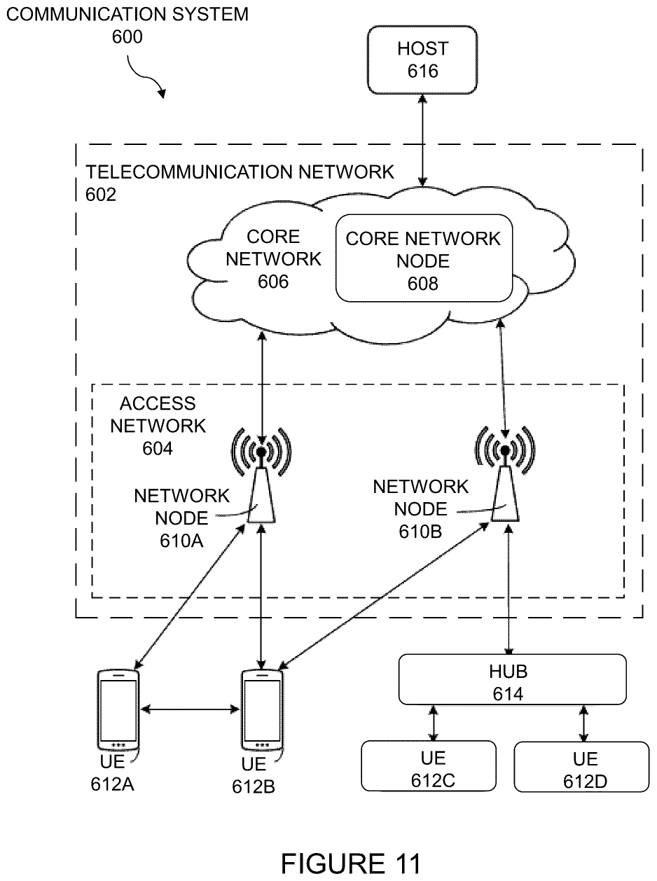

FIG. 11 shows an example of a communication system 600 in accordance with some embodiments. In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

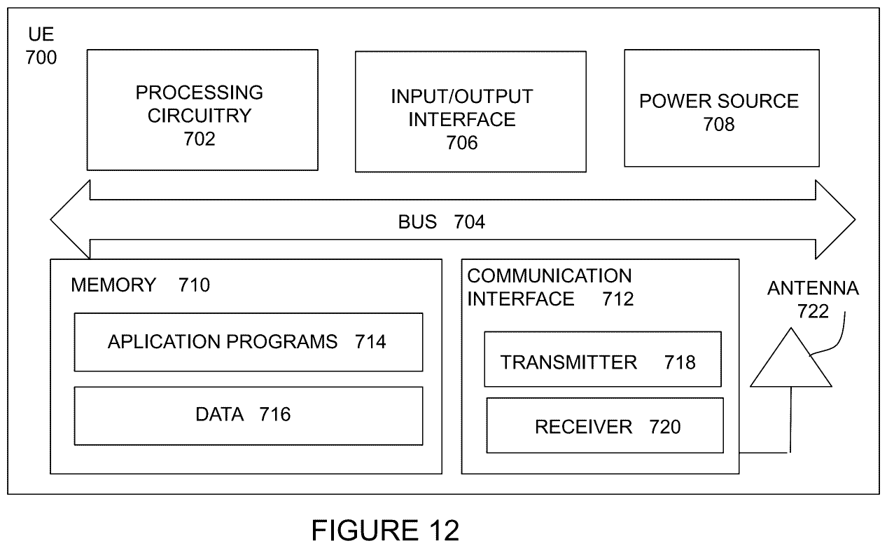

FIG. 12 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, play back appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

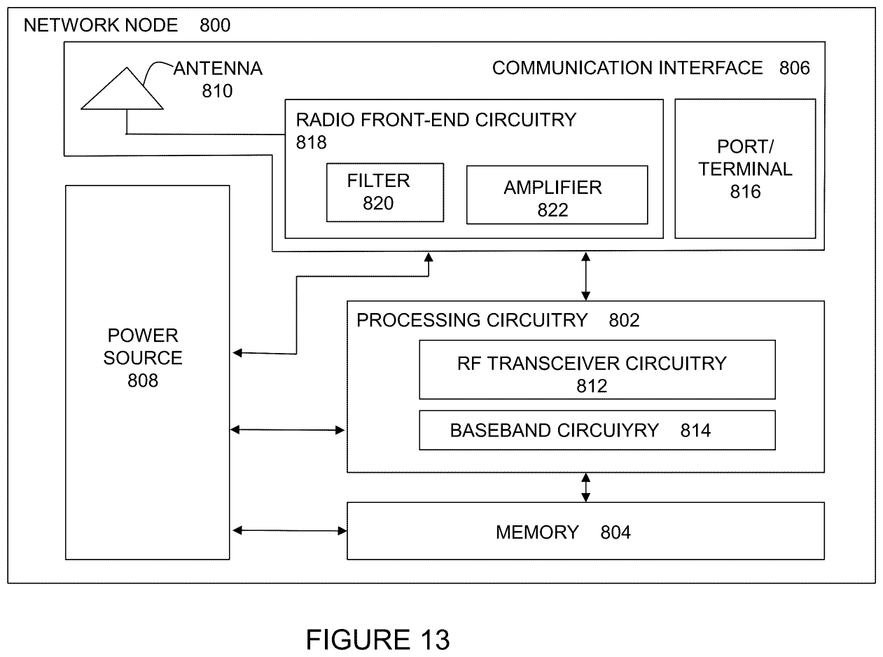

FIG. 13 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 13 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

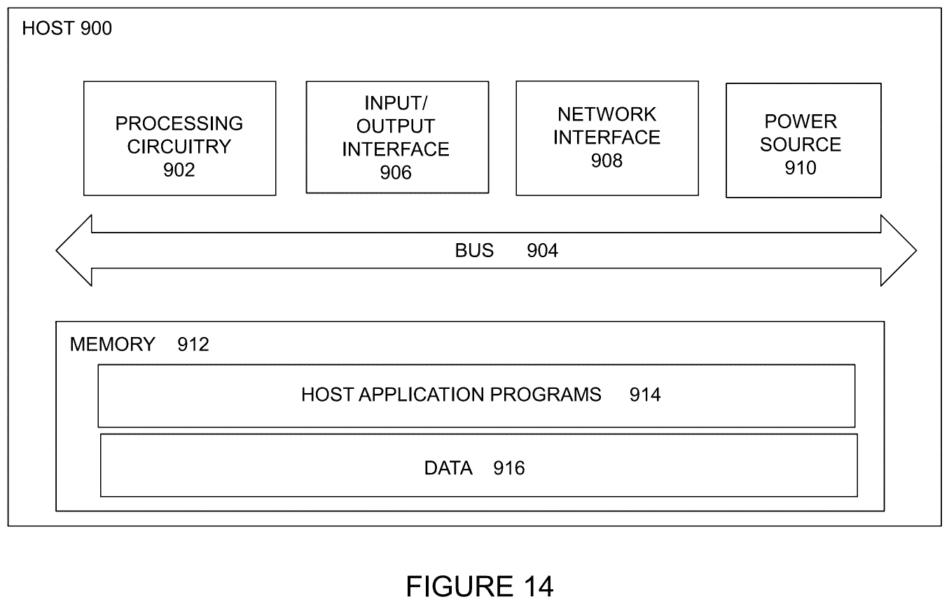

FIG. 14 is a block diagram of a host 900, which may be an embodiment of the host 616 of FIG. 11, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

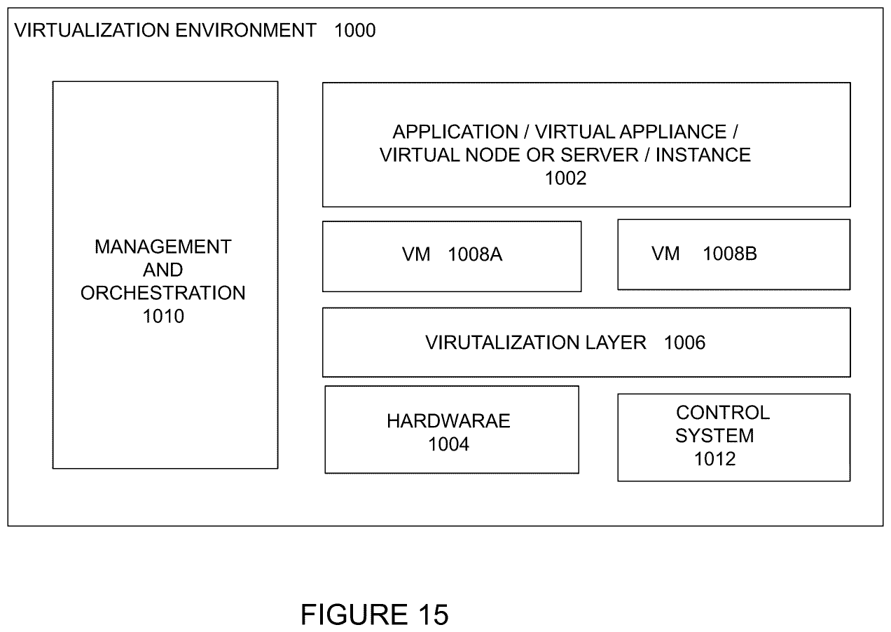

FIG. 15 is a block diagram illustrating a virtualization environment 1000 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

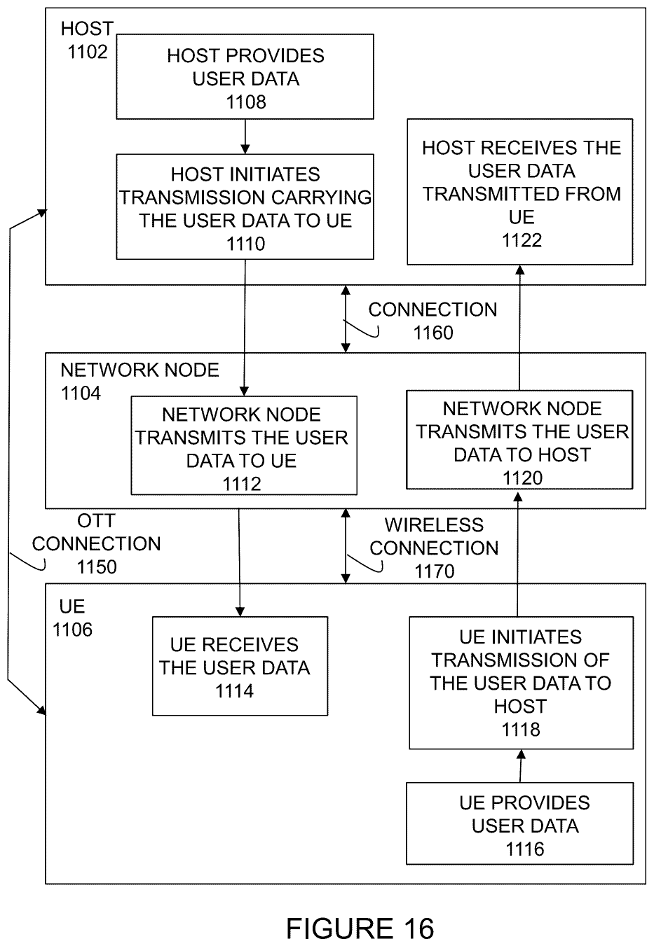

FIG. 16 shows a communication diagram of a host 1102 communicating via a network node 1104 with a UE 1106 over a partially wireless connection in accordance with some embodiments.

Example implementations, in accordance with various embodiments, of the UE (such as a UE 612a of FIG. 11 and/or UE 700 of FIG. 12), network node (such as network node 610a of FIG. 11 and/or network node 800 of FIG. 13), and host (such as host 616 of FIG. 11 and/or host 900 of FIG. 14) discussed in the preceding paragraphs will now be described with reference to FIG. 16.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 11) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

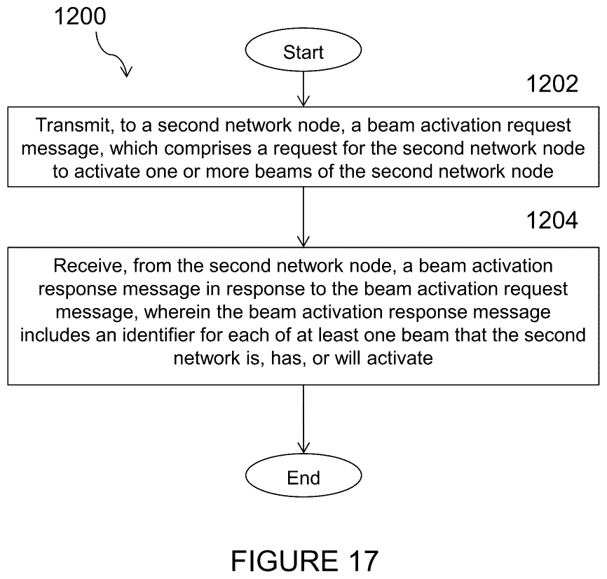

FIG. 17 illustrates an example method 1200 by a first network node 105 for on-demand beam activation in a second network node 110, according to certain embodiments. The method begins at step 1202 when the first network node 105 transmits, to the second network node 110, a beam activation request message, which includes a request for the second network node 110 to activate one or more beams of the second network node 110. At step 1204, the first network node 105 receives, from the second network node 110, a beam activation response message in response to the beam activation request message. The beam activation response message includes an identifier for each of at least one beam that the second network node 110 is, has, or will activate.

In a particular embodiment, the beam activation response message is or includes a positive acknowledgment in response to the beam activation request message.

In a particular embodiment, the beam activation response message includes an indication that the second network node 110 is, has, or will activate at least a portion of the one or more beams.

In a particular embodiment, the beam activation response message includes an identifier associated with at least one activated beam that is not associated with the beam activation request message.

In a particular embodiment, the beam activation request message includes a request for the second network node 110 to perform or not perform at least one function associated with the one or more beams of the second network node 110.

In a further particular embodiment, performing or not performing the at least one function comprises at least one of: transmitting or not transmitting SI via the one or more beams; transmitting or not transmitting a multicast broadcast service via the one or more beams; transmitting or not transmitting a paging message via the one or more beams; and activating or deactivating DTRX for the one or more beams.

In a particular embodiment, the first network node 105 transmits the beam activation request message to the second network node 110 when the second network node 110 is active but the one or more beams are not active.

In a particular embodiment, the method further includes the first network node 105 transmitting, to the second network node 110, a second beam activation request message, which includes a request for the second network node 110 to activate one or more beams of the second network node 110. The first network node 105 receives, from the second network node 110, a second beam activation response message, and the second beam activation response message includes a negative acknowledgement in response to the second beam activation request message.

In a further particular embodiment, the second beam activation response message includes an indication that the second network node 110 cannot or will not activate the one or more beams associated with the second beam activation request message.

In a further particular embodiment, the negative acknowledgement includes an indication of a cause or reason that the second network node 110 cannot or will not perform at least one action associated with the second beam activation request message.

In a particular embodiment, prior to transmitting the beam activation request message, the first network node 105 receives a beam configuration from the second network node 110. In a particular embodiment, the first network node 105 is a first RAN node and the second network node is a second RAN node.

In a particular embodiment, the first network node 105 is a first logical entity of a first RAN node and the second network node 110 is a second logical entity of the first RAN node or a second RAN node.

In a particular embodiment, the first network node 105 is CU of a first RAN node and the second network node 110 is a DU of the first RAN node or a second RAN node.

In a particular embodiment, the beam activation request message is transmitted, and the beam activation response message is received, over F1 or Xn interface.

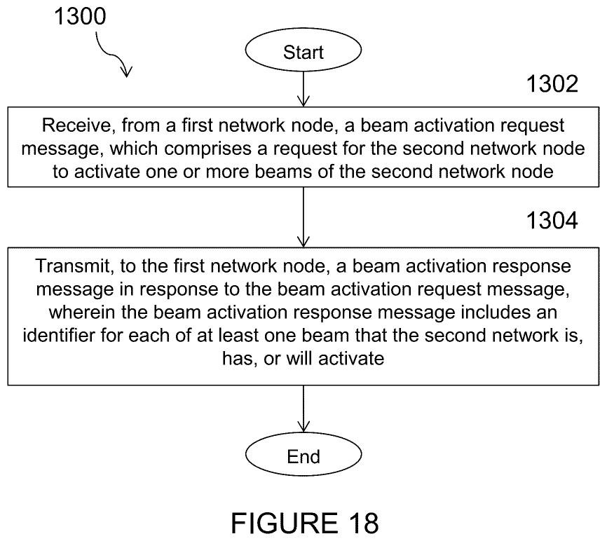

FIG. 18 illustrates an example method 1300 by a second network node 110 for on-demand beam activation by a first network node 105, according to certain embodiments. The method begins at step 1302 when the second network node 110 receives, from the first network node 105, a beam activation request message, which includes a request for the second network node 110 to activate one or more beams of the second network node 110, At step 1304, the second network node 110 transmits, to the first network node 105, a beam activation response message in response to the beam activation request message, which includes an identifier for each of at least one beam that the second network node 110 is, has, or will activate.

In a particular embodiment, the second network node 110 activates at least one beam of the second network node 110.

In a particular embodiment, the beam activation response message is or includes a positive acknowledgement in response to the beam activation request message.

In a particular embodiment, the beam activation response message includes an indication that the second network node 110 is, has, or will activate at least a portion of the one or more beams.

In a particular embodiment, the beam activation response message includes an identifier associated with at least one activated beam that is not associated with the beam activation request message.

In a particular embodiment, the beam activation request message includes a request for the second network node 110 to perform or not perform at least one function associated with the one or more beams of the second network node 110.

In a particular embodiment, performing or not performing the at least one function comprises at least one of: transmitting or not transmitting SI via the one or more beams; transmitting or not transmitting a multicast broadcast service via the one or more beams; transmitting or not transmitting a paging message via the one or more beams; and activating or deactivating DTRX for the one or more beams.

In a particular embodiment, performing or not performing the at least one action and/or the at least one function associated with the one or more beams.

In a particular embodiment, the second network node 110 receives the beam activation request message from the first network node 105 when the second network node 105 is active but the one or more beams are not active.

In a particular embodiment, the second network node 110 receives, from the first network node 105, a second beam activation request message, which includes a request for the second network node 110 to activate one or more beams of the second network node 110. The second network node 110 transmits, to the first network node 105, a second beam activation response message, and the second beam activation response message includes a negative acknowledgement in response to the second beam activation request message.

In a further particular embodiment, the second beam activation response message includes an indication that the second network node 110 cannot or will not activate the one or more beams associated with the second beam activation request message.

In a further particular embodiment, the negative acknowledgement includes an indication of a cause or reason that the second network 110 cannot or will not perform at least one action associated with the second beam activation request message.

In a particular embodiment, prior to receiving the beam activation request message, the second network node 110 transmits a beam configuration to the first network node.

In a particular embodiment, the first network node is a first RAN node and the second network node is a second RAN node.

In a particular embodiment, the first network node 105 is a first logical entity of a first RAN node and the second network node 110 is a second logical entity of the first RAN node or a second RAN node.

In a particular embodiment, the first network node 105 is CU of a first RAN node and the second network node 110 is a DU of the first RAN node or a second RAN node.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for on-demand beam activation in another node, the method comprising: any of the user equipment steps, features, or functions described above, either alone or in combination with other steps, features, or functions described above.
Example Embodiment A2. The method of the previous embodiment, further comprising one or more additional user equipment steps, features or functions described above.
Example Embodiment A3. The method of any of the previous embodiments, further comprising: providing user data; and forwarding the user data to a host computer via the transmission to the network node.

### Group B Example Embodiments

Example Embodiment B1. A method performed by a network node for on-demand beam activation in another node, the method comprising: any of the network node steps, features, or functions described above, either alone or in combination with other steps, features, or functions described above.
Example Embodiment B2. The method of the previous embodiment, further comprising one or more additional network node steps, features or functions described above.
Example Embodiment B3. The method of any of the previous embodiments, further comprising: obtaining user data; and forwarding the user data to a host or a user equipment.

### Group C Example Embodiments

Example Embodiment C1. A method by a first network node for on-demand beam activation in a second network node, the method comprising: transmitting, to a second network node, a beam activation request message; and receiving, from the second network node, a beam activation response message.
Example Embodiment C2. The method of Example Embodiment C1, wherein the beam activation request message comprises a request associated with one or more beams of the second network node.
Example Embodiment C3a. The method of any one of Example Embodiments C1 to C2, wherein the beam activation request message comprises a request for the second network node to perform at least one action, and wherein the at least one action comprises any one or more of: activating one or more beams of the second network node, reactivating one or more beams of the second network node, activating and/or performing at least one function associated with one or more beams of the second network node, not activating or not performing at least one function associated with one or more beams of the second network node, and changing a configuration of one or more beams of the second network node,
Example Embodiment C3b. The method of Example Embodiment C3a, wherein performing or not performing the at least one function comprises at least one of: transmitting or not transmitting system information (SI) via the one or more beams; transmitting or not transmitting a multicast broadcast service via the one or more beams; transmitting or not transmitting a paging message via the one or more beams; and activating or deactivating DTRX for the one or more beams.
Example Embodiment C4. The method of any one of Example Embodiments C1 to C3b, wherein the beam activation response message comprises a positive acknowledgement in response to the beam activation request message.
Example Embodiment C5. The method of Example Embodiment C4, wherein the beam activation response message comprises at least one of: an indication that the second network node is, has, or will activate at least a portion of the one or more beams associated with the beam activation request message; an indication that the second network node is, has, or will reactivate at least a portion of the one or more beams associated with the beam activation request message; and an indication that the second network node is, has, or will apply the configuration to at least a portion of the one or more beams associated with the beam activation request message a beam activation accept message.
Example Embodiment C5b. The method of any one of Example Embodiments C4 to C5a, wherein the beam activation response message comprises an identifier for each one of the at least one beams that the second network node is, has, or will activate.
Example Embodiment C5c. The method of Example Embodiment C5b, wherein the beam activation response message comprises an identifier associated with at least one activated beams that is not associated with the beam activation request message.
Example Embodiment C6. The method of any one of Example Embodiments C1 to C3, wherein the beam activation response message comprises one or more alternative beams of the second network node in response to the beam activation request message, wherein at least one of the alternative beams is different from the one or more beams associated with the beam activation request message.
Example Embodiment C7. The method of Example Embodiment C6, wherein the beam activation response message comprises at least one of: an indication that the second network node is, has, or will activate the one or more alternative beams of the second network node; an indication that the second network node is, has, or will reactivate the one or more alternative beams of the second network node; and an indication that the second network node is, has, or will apply the configuration of the one or more alternative beams of the second network node.
Example Embodiment C8. The method of any one of Example Embodiments C1 to C3, wherein the beam activation response message comprises a negative acknowledgement in response to the beam activation request message.
Example Embodiment C9. The method of Example Embodiment C8, wherein the beam activation response message comprises at least one of: an indication that the second network node cannot or will not activate the one or more beams associated with the beam activation request message; an indication that the second network node cannot or will not reactivate the one or more beams associated with the beam activation request message; and an indication that the second network node cannot or will not apply the configuration of the one or more beams associated with the beam activation request message a beam activation accept message.
Example Embodiment C10. The method of any one of Example Embodiments C8 to C9, wherein the negative acknowledgement comprises an indication of a cause or reason that the second network cannot or will not perform at least one action associated with the beam activation request message.
Example Embodiment C11. The method of any one of Example Embodiments C1 to C10, wherein prior to transmitting the beam activation request message, the method comprises receiving a beam configuration from the second network node.
Example Embodiment C12. The method of Example Embodiment C11, wherein the beam configuration is received from the second network node on a periodic basis.
Example Embodiment C13. The method of Example Embodiment C11, wherein the beam configuration is received from the second network node in response to a modification or reconfiguration of the beam configuration at the second network node.
Example Embodiment C14. The method of any one of Example Embodiments C11, wherein prior to receiving the beam configuration, the method comprises transmitting, to the second network node, a beam configuration request message.
Example embodiment C15. The method of any one of Example Embodiments C11 to C14, wherein the second network node is in active mode.
Example Embodiment C16. The method of any one of Example Embodiments C11 to C14, wherein the second network node is transitioning into inactive or deactivated mode.
Example Embodiment C17. The method of any one of Example Embodiments C11 to C14, wherein the second network node is inactive.
Example Embodiment C18. The method of Example Embodiment C11 and C17, wherein the beam configuration request message is transmitted to the second network node with a request for the second network node to become active.
Example Embodiment C19. The method of any one of Example Embodiments C11 to C18, comprising: in response to receiving the beam configuration from the second network node, starting a timer; and upon determining that the timer has expired, transmitting a request for an updated beam configuration from the second network node.
Example Embodiment C20. The method of any one of Example Embodiments C1 to C19, comprising transmitting, to the second network node, a DTRX configuration (i.e., on or off) for a cell associated with the one or more beams.
Example Embodiment C21. The method of Example Embodiment C20, comprising receiving a positive acknowledgement indicating that the DTRX configuration has been fulfilled by the second network node.
Example Embodiment C22. The method of Example Embodiment C20, comprising receiving a negative acknowledgement indicating that the DTRX configuration has not been fulfilled by the second network node.
Example Embodiment C23. The method of any one of Example Embodiments C1 to C22, wherein the first network node is a first RAN node and the second network node is a second RAN node.
Example Embodiment C24. The method of any one of Example Embodiments C1 to C22, wherein the first network node is a first NG-RAN node and the second network node is a second NG-RAN node.
Example Embodiment C25. The method of any one of Example Embodiments C1 to C22, wherein the first network node is a first NG-RAN node and the second network node is a second eNodeB of an E-UTRAN system.
Example Embodiment C26. The method of any one of Example Embodiments C1 to C22, wherein the first network node is a first logical entity of a RAN node and the second network node is a second logical entity of the RAN node.
Example Embodiment C27. The method of any one of Example Embodiments C1 to C22, wherein the first network node is a first logical entity of a first RAN node and the second network node is a first logical entity of a second RAN node.
Example Embodiment C28. The method of any one of Example Embodiments C1 to C22, wherein the first network node is Distributed Unit (DU) of a RAN node and the second network node is a Centralized Unit (CU) of the RAN node.
Example Embodiment C29. The method of any one of Example Embodiments C1 to C22, wherein the first network node is CU of a RAN node and the second network node is a DU of the RAN node.
Example Embodiment C30. The method of any one of Example Embodiments C1 to C22, wherein the first network node is a CU of a first RAN node and the second network node is a CU of a second RAN node.
Example Embodiment C31. The method of any one of Example Embodiments C1 to C22, wherein the first network node is a DU of a first RAN node and the second network node is a DU of a second RAN node.
Example Embodiment C32. The method of Example Embodiments C1 to C31, further comprising: obtaining user data; and forwarding the user data to a host or a user equipment.
Example Embodiment C33. A first network node configured to perform any of the methods of Example Embodiments C1 to C32.
Example Embodiment C34. A first network node comprising processing circuitry configured to perform any of the methods of Example Embodiments C1 to C32.
Example Embodiment C35. A computer program comprising instructions which when executed on a computer perform any of the methods of Example Embodiments C1 to C32.
Example Embodiment C36. A computer program product comprising computer program, the computer program comprising instructions which when executed on a computer perform any of the methods of Example Embodiments C1 to C32.
Example Embodiment C37. A non-transitory computer readable medium storing instructions which when executed by a computer perform any of the methods of Example Embodiments C1 to C32.

### Group D Example Embodiments

Example Embodiment D1. A method by a second network node for on-demand beam activation by another node, the method comprising: receiving, from a first network node, a beam activation request message; and transmitting, to the first network node, a beam activation response message.
Example Embodiment D2. The method of Example Embodiment D1, wherein the beam activation request message comprises a request associated with one or more beams of the second network node.
Example Embodiment D3a. The method of any one of Example Embodiments D1 to D2, wherein the beam activation request message comprises a request for the second network node to perform at least one action, and wherein the at least one action comprises any one or more of: activating one or more beams of the second network node, reactivating one or more beams of the second network node, activating and/or performing at least one function associated with one or more beams of the second network node, not activating or not performing at least one function associated with one or more beams of the second network node, and changing a configuration of one or more beams of the second network node.
Example Embodiment D3b. The method of Example Embodiment D3a, comprising performing or not performing the at least one action based on the beam activation request message.
Example Embodiment D3c. The method of any one of Example Embodiments D3a to D3, comprising performing or not performing the at least one function based on the beam activation request message, wherein the at least one function comprises at least one of: transmitting or not transmitting system information (SI) via the one or more beams; transmitting or not transmitting a multicast broadcast service via the one or more beams; transmitting or not transmitting a paging message via the one or more beams; and activating or deactivating DTRX for the one or more beams.
Example Embodiment D4. The method of any one of Example Embodiments D1 to D3b, wherein the beam activation response message comprises a positive acknowledgement in response to the beam activation request message.
Example Embodiment D5. The method of Example Embodiment D4, wherein the beam activation response message comprises at least one of: an indication that the second network node is, has, or will activate at least a portion of the one or more beams associated with the beam activation request message; an indication that the second network node is, has, or will reactivate at least a portion of the one or more beams associated with the beam activation request message; and an indication that the second network node is, has, or will apply the configuration to at least a portion of the one or more beams associated with the beam activation request message a beam activation accept message.
Example Embodiment D5b. The method of any one of Example Embodiments D4 to D5a, wherein the beam activation response message comprises an identifier for each one of the at least one beams that the second network node is, has, or will activate.
Example Embodiment D5c. The method of Example Embodiment D5b, wherein the beam activation response message comprises an identifier associated with at least one activated beams that is not associated with the beam activation request message.
Example Embodiment D6. The method of any one of Example Embodiments D1 to D3, wherein the beam activation response message comprises one or more alternative beams of the second network node in response to the beam activation request message, wherein at least one of the alternative beams is different from the one or more beams associated with the beam activation request message.
Example Embodiment D7. The method of Example Embodiment D6, wherein the beam activation response message comprises at least one of: an indication that the second network node is, has, or will activate the one or more alternative beams of the second network node; an indication that the second network node is, has, or will reactivate the one or more alternative beams of the second network node; and an indication that the second network node is, has, or will apply the configuration of the one or more alternative beams of the second network node.
Example Embodiment D8. The method of any one of Example Embodiments D1 to D3, wherein the beam activation response message comprises a negative acknowledgement in response to the beam activation request message.
Example Embodiment D9. The method of Example Embodiment D8, wherein the beam activation response message comprises at least one of: an indication that the second network node cannot or will not activate the one or more beams associated with the beam activation request message; an indication that the second network node cannot or will not reactivate the one or more beams associated with the beam activation request message; and an indication that the second network node cannot or will not apply the configuration of the one or more beams associated with the beam activation request message a beam activation accept message.
Example Embodiment D10. The method of any one of Example Embodiments D8 to D9, wherein the negative acknowledgement comprises an indication of a cause or reason that the second network cannot or will not perform at least one action associated with the beam activation request message.
Example Embodiment D11. The method of any one of Example Embodiments D1 to D10, wherein prior to receiving the beam activation request message, the method comprises transmitting a beam configuration to the first network node.
Example Embodiment D12. The method of Example Embodiment D11, wherein the beam configuration is transmitted by the second network node on a periodic basis.
Example Embodiment D13. The method of Example Embodiment D11, wherein the beam configuration is transmitted by the second network node in response to a modification or reconfiguration of the beam configuration at the second network node.
Example Embodiment D14. The method of Example Embodiment D11, wherein prior to receiving the beam configuration, the method comprises receiving, from the first network node, a beam configuration request message.
Example embodiment D15. The method of any one of Example Embodiments D11 to D14, wherein the second network node is in active mode.
Example Embodiment D16. The method of any one of Example Embodiments D11 to D14, wherein the second network node is transitioning into inactive or deactivated mode.
Example Embodiment D17. The method of any one of Example Embodiments D11 to D14, wherein the second network node is inactive.
Example Embodiment D18. The method of Example Embodiment D11 and D17, wherein the beam configuration request message is received from the first network node with a request for the second network node to become active.
Example Embodiment D19. The method of any one of Example Embodiments D11 to D18, comprising receiving a request for an update beam configuration from the first network node, wherein the request is in associated with an expiration of a timer.
Example Embodiment D20. The method of any one of Example Embodiments D1 to D19, comprising receiving, from the first network node, a DTRX configuration (i.e., on or off) for a cell associated with the one or more beams.
Example Embodiment D21. The method of Example Embodiment D20, comprising transmitting, to the first network node, a positive acknowledgement indicating that the DTRX configuration has been fulfilled by the second network node.
Example Embodiment D22. The method of Example Embodiment D20, comprising transmitting a negative acknowledgement indicating that the DTRX configuration has not been fulfilled by the second network node.
Example Embodiment D23. The method of any one of Example Embodiments D1 to D22, wherein the first network node is a first RAN node and the second network node is a second RAN node.
Example Embodiment D24. The method of any one of Example Embodiments D1 to D22, wherein the first network node is a first NG-RAN node and the second network node is a second NG-RAN node.
Example Embodiment D25. The method of any one of Example Embodiments D1 to D22, wherein the first network node is a first NG-RAN node and the second network node is a second eNodeB of an E-UTRAN system.
Example Embodiment D26. The method of any one of Example Embodiments D1 to D22, wherein the first network node is a first logical entity of a RAN node and the second network node is a second logical entity of the RAN node.
Example Embodiment D27. The method of any one of Example Embodiments D1 to D22, wherein the first network node is a first logical entity of a first RAN node and the second network node is a first logical entity of a second RAN node.
Example Embodiment D28. The method of any one of Example Embodiments D1 to D22, wherein the first network node is Distributed Unit (DU) of a RAN node and the second network node is a Centralized Unit (CU) of the RAN node.
Example Embodiment D29. The method of any one of Example Embodiments D1 to D22, wherein the first network node is CU of a RAN node and the second network node is a DU of the RAN node.
Example Embodiment D30. The method of any one of Example Embodiments D1 to D22, wherein the first network node is a CU of a first RAN node and the second network node is a CU of a second RAN node.
Example Embodiment D31. The method of any one of Example Embodiments D1 to D22, wherein the first network node is a DU of a first RAN node and the second network node is a DU of a second RAN node.
Example Embodiment D32. The method of any of the previous Example Embodiments, further comprising: obtaining user data; and forwarding the user data to a host or a user equipment.
Example Embodiment D33. A network node configured to perform any of the methods of Example Embodiments D1 to D32.
Example Embodiment D34. A network node comprising processing circuitry configured to perform any of the methods of Example Embodiments D1 to D32.
Example Embodiment D34. A computer program comprising instructions which when executed on a computer perform any of the methods of Example Embodiments D1 to D32
Example Embodiment D35. A computer program product comprising computer program, the computer program comprising instructions which when executed on a computer perform any of the methods of Example Embodiments D1 to D32.
Example Embodiment D36. A non-transitory computer readable medium storing instructions which when executed by a computer perform any of the methods of Example Embodiments D1 to D32.

### Group E Example Embodiments

Example Embodiment E1. A user equipment for on-demand beam activation in another node, comprising: processing circuitry configured to perform any of the steps of any of the Group A Example Embodiments; and power supply circuitry configured to supply power to the processing circuitry.
Example Embodiment E2. A network node for on-demand beam activation in another node, the network node comprising: processing circuitry configured to perform any of the steps of any of the Group B, C, and D Example Embodiments; power supply circuitry configured to supply power to the processing circuitry.
Example Embodiment E3. A user equipment (UE) for on-demand beam activation in another node, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.
Example Embodiment E5. The host of the previous Example Embodiment, wherein the cellular network further includes a network node configured to communicate with the UE to transmit the user data to the UE from the host.
Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Example Embodiment E8. The method of the previous Example Embodiment, further comprising: at the host, executing a host application associated with a client application executing on the UE to receive the user data from the UE.
Example Embodiment E9. The method of the previous Example Embodiment, further comprising: at the host, transmitting input data to the client application executing on the UE, the input data being provided by executing the host application, wherein the user data is provided by the client application in response to the input data from the host application.
Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.
Example Embodiment E11. The host of the previous Example Embodiment, wherein the cellular network further includes a network node configured to communicate with the UE to transmit the user data from the UE to the host.
Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.
Example Embodiment E14. The method of the previous Example Embodiment, further comprising: at the host, executing a host application associated with a client application executing on the UE to receive the user data from the UE.
Example Embodiment E15. The method of the previous Example Embodiment, further comprising: at the host, transmitting input data to the client application executing on the UE, the input data being provided by executing the host application, wherein the user data is provided by the client application in response to the input data from the host application.
Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, and D Example Embodiments to transmit the user data from the host to the UE.
Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.
Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, and D Example Embodiments to transmit the user data from the host to the UE.
Example Embodiment E19. The method of the previous Example Embodiment, further comprising, at the network node, transmitting the user data provided by the host for the UE.
Example Embodiment E20. The method of any of the previous 2 Example Embodiments, wherein the user data is provided at the host by executing a host application that interacts with a client application executing on the UE, the client application being associated with the host application.
Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, and D Example Embodiments to transmit the user data from the host to the UE.
Example Embodiment E22. The communication system of the previous Example Embodiment, further comprising: the network node; and/or the user equipment
Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, and D Example Embodiments to receive the user data from a user equipment (UE) for the host.
Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E25. The host of the any of the previous 2 Example Embodiments, wherein the initiating receipt of the user data comprises requesting the user data.
Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, and D Example Embodiments to receive the user data from the UE for the host.
Example Embodiment E27. The method of the previous Example Embodiment, further comprising at the network node, transmitting the received user data to the host.

1.-36. (canceled)

37. A method by a first network node for on-demand beam activation in a second network node, the method comprising:
transmitting, to the second network node, a beam activation request message comprising a request for the second network node to activate one or more beams of the second network node; and
receiving, from the second network node, a beam activation response message in response to the beam activation request message;
wherein the beam activation response message comprises an identifier for each of at least one beam that the second network node is, has, or will activate.

38. The method of claim 37, wherein the beam activation response message comprises a positive acknowledgement in response to the beam activation request message.

39. The method of claim 37, wherein the beam activation response message comprises an indication that the second network node is, has, or will activate at least a portion of the one or more beams.

40. The method of claim 37, wherein the beam activation response message comprises an identifier associated with at least one activated beam that is not associated with the beam activation request message.

41. The method of claim 37, wherein:
the beam activation request message comprises a request for the second network node to perform or not perform at least one function associated with the one or more beams of the second network node; and
performing or not performing the at least one function comprises at least one of:
transmitting or not transmitting system information, SI, via the one or more beams;
transmitting or not transmitting a multicast broadcast service via the one or more beams;
transmitting or not transmitting a paging message via the one or more beams; and
activating or deactivating Discontinuous Transmission Reception, DTRX, for the one or more beams.

42. The method of claim 37, wherein the first network node transmits the beam activation request message to the second network node when the second network node is active but the one or more beams are not active.

43. The method of claim 37, further comprising:
transmitting, to the second network node, a second beam activation request message comprising a request for the second network node to activate one or more beams of the second network node; and
receiving, from the second network node, a second beam activation response message, and
wherein the second beam activation response message comprises a negative acknowledgement in response to the second beam activation request message.

44. The method of claim 43, wherein the second beam activation response message comprises an indication that the second network node cannot or will not activate the one or more beams associated with the second beam activation request message.

45. The method of claim 44, wherein the negative acknowledgement comprises an indication of a cause or reason that the second network cannot or will not perform at least one action associated with the second beam activation request message.

46. The method of claim 37, wherein prior to transmitting the beam activation request message, the method comprises receiving a beam configuration from the second network node.

47. A method by a second network node for on-demand beam activation by a first network node, the method comprising:
receiving, from the first network node, a beam activation request message comprising a request for the second network node to activate one or more beams of the second network node; and
transmitting, to the first network node, a beam activation response message in response to the beam activation request message, and
wherein the beam activation response message comprises an identifier for each of at least one beam that the second network node is, has, or will activate.

48. The method of claim 47, comprising activating at least one beam of the second network node.

49. The method of claim 47, wherein the beam activation response message comprises a positive acknowledgement in response to the beam activation request message.

50. The method of claim 47, wherein the beam activation response message comprises an indication that the second network node is, has, or will activate at least a portion of the one or more beams.

51. The method of claim 47, wherein the beam activation response message comprises an identifier associated with at least one activated beam that is not associated with the beam activation request message.

52. The method of claim 47, wherein:
the beam activation request message comprises a request for the second network node to perform or not perform at least one function associated with the one or more beams of the second network node; and
performing or not performing the at least one function comprises at least one of:
transmitting or not transmitting system information, SI, via the one or more beams;
transmitting or not transmitting a multicast broadcast service via the one or more beams;
transmitting or not transmitting a paging message via the one or more beams; and
activating or deactivating Discontinuous Transmission Reception, DTRX, for the one or more beams.

53. The method according to claim 47, comprising performing or not performing the at least one function associated with the one or more beams.

54. The method of claim 47, wherein the second network node receives the beam activation request message from the first network node when the second network node is active but the one or more beams are not active.

55. The method of claim 47, wherein prior to receiving the beam activation request message, the method comprises transmitting a beam configuration to the first network node.

56. A network node comprising processing circuitry configured to perform any of claim 47.
